(19) United States
(12) Patent Application Publication
(10) Pub. No.: US 2022/0250967 A1
(43) Pub. Date: Aug. 11, 2022

(54) YTTRIA-CONTAINING GLASS SUBSTRATE

(71) Applicant: CORNING INCORPORATED, CORNING, NY (US)

(72) Inventors: Timothy Michael Gross, Painted Post, NY (US); Alexandra Lai Ching Kao Andrews Mitchell, Ithaca, NY (US)

(21) Appl. No.: 17/618,644

(22) PCT Filed: Jun. 4, 2020
(86) PCT No.: PCT/US2020/036017

§ 371 Date: Dec. 13, 2021

Related U.S. Application Data
(60) Provisional application No. 62/863,550, filed on Jun. 19, 2019.

(51) Int. Cl. C03C 3/095

(52) U.S. Cl. CPC C03C 3/095

(57) ABSTRACT

A glass substrate includes about 45 mol % to about 70 mol % SiO₂, about 15 mol % to about 30 mol % Al₂O₃, about 7 mol % to about 20 mol % of Y₂O₃, and optionally 0 mol % to about 9 mol % of La₂O₃. The glass substrate has high modulus and fracture toughness.

### PRIORITY CLAIM AND CROSS-REFERENCE

This application claims the benefit of priority under 35 U.S.C. § 119 of U.S. Provisional Application Ser. No. 62/863,550 filed on Jun. 19, 2019, the content of which is relied upon and incorporated herein by reference in its entirety.

### FIELD

The disclosure relates to glass composition generally. More particularly, the disclosed subject matter relates to glass substrate having high modulus and fracture toughness.

### BACKGROUND

Flat or curved substrates made of an optically transparent material such as glass are used for flat panel display, photovoltaic devices, and other suitable applications. Thin film transistors (TFTs) may be built on glass substrates for display application. The glass compositions used for display applications need to have optical clarity, good thermal and mechanical properties, and dimensional stability satisfying the processing and performance requirements. In addition, diffusion of meal ions into the thin film transistors, which cause damages to the transistors, needs to be avoided.

Rigid glass is also used for information recording discs such as magnetic disk, optical disk, and memory disks in hard-disk drives (HDDs). The demand for higher data storage capacity and performance in memory disks also drives the need for glass compositions having improved performance.

Glass is a brittle material, and can sometimes break during use. The fracture toughness of commercially used glasses is usually close to or below 0.8 MPa*m^{0.5}. There are continued needs to obtain glasses with high fracture toughness to improve damage resistance and/or drop performance.

### SUMMARY

The present disclosure provides a glass composition, a glass substrate, a method of making the same and a method of using the same. The present disclosure also provides an article comprising such a glass composition or a glass substrate, and a device comprising such a glass a substrate having such a glass composition.

In accordance with some embodiments, a glass substrate comprising:

about 45 mol % to about 70 mol % SiO₂;

about 15 mol % to about 30 mol % Al₂O₃;

about 7 mol % to about 20 mol % of Y₂O₃; and

optionally 0 mol % to about 9 mol % of La₂O₃.

In some embodiments, the glass substrate comprises about 27 mol % to about 43 mol % of R₂O₃, and wherein R₂O₃ comprises Al₂O₃, Y₂O₃, and La₂O₃ in total. Examples of a suitable range of R₂O₃ content include, but are not limited to, about 28 mol % to about 40 mol %, about 30 mol % to about 40 mol %, or about 32 mol % to about 38 mol %. In some embodiments, the glass substrate has a molar ratio of [(Y₂O₃+La₂O₃)/Al₂O₃] in a range of from about 0.3 to about 1.7, for example, from about 0.5 to about 1.7, or from about 1 to about 1.5.

In the glass substrate, SiO₂ is present in any suitable range. Examples of a suitable range include, but are not limited to, about 50 mol % to about 70 mol %, about 52 mol % to about 70 mol %, about 52 mol % to about 66 mol %, about 54 mol % to about 66 mol %, or about 60 mol % to about 66 mol %.

In some embodiments, Al₂O₃ has a content of equal to or above 15 mol %. Examples of a suitable range of Al₂O₃ include, but are not limited to, about 16 mol % to about 30 mol %, about 17 mol % to about 30 mol %, about 18 mol % to about 30 mol %, about 18 mol % to about 28 mol %, or about 18 mol % to about 25 mol %.

In some embodiments, Y₂O₃ has a content of equal to or above 7 mol %. Examples of a suitable range of Y₂O₃ include, but are not limited to, about 8 mol % to about 20 mol %, about 9 mol % to about 20 mol %, about 7 mol % to about 16 mol %, about 7 mol % to about 15 mol %, about 8 mol % to about 16 mol %, or about 10 mol % to about 16 mol %.

La₂O₃ is optional. Examples of a suitable range of La₂O₃ include, but are not limited to, about 0.1 mol % to about 9 mol %, about 1 mol % to about 9 mol %, about 2 mol % to about 9 mol %, or about 3 mol % to about 9 mol %. When the glass substrate comprises La₂O₃, such a glass substrate does not contain B₂O₃.

In some other embodiments, the glass substrate further comprises 0 mol % to about 6 mol % of B₂O₃, for example, 0.1 mol % to about 6 mol % of B₂O₃, or 0.1 mol % to about 1 mol % of B₂O₃. When B₂O₃ is added, the glass substrate is substantially free of La₂O₃.

The glass substrate may further comprise 0 mol % to about 6 mol % of MgO, for example, 0 to about 5 mol %, 0 to about 4 mol %, 0 to about 3 mol %, about 0.1% to about 5 mol %, about 0.1% to about 4 mol %, about 0.1 mol % to about 3 mol %.

The glass substrate may also further comprise 0 mol % to about 12 mol % of an alkali metal oxide such as Li₂O, Na₂O, K₂O, or a combination thereof.

In some embodiments, a molar percentage difference of (Al₂O₃—R₂O—RO) is in a range of about 7 to about 22, for example, about 7.1 to about 21.6, about 10 to about 20, or about 15 to about 20. R₂O comprises an alkali metal oxide selected from the group consisting of Na₂O, K₂O, and any combination thereof. RO comprises an alkaline earth metal oxide selected from the group consisting of MgO, SrO, BaO, and any combination thereof. The glass substrate is substantially free of CaO.

In addition to CaO, the glass substrate is substantially free of CaO, Eu₂O₃, Nb₂O₃, Si₃N₄, WO₃, ZrO₄, and TiO₂ in some embodiments.

In accordance with some embodiments, the present disclosure provides a glass substrate consisting essentially of:

about 45 mol % to about 70 mol % SiO₂;

about 15 mol % to about 30 mol % Al₂O₃;

about 7 mol % to about 20 mol % of Y₂O₃;

0 mol % to about 9 mol % of La₂O₃;

0 mol % to about 6 mol % of MgO; and

0 mol % to about 12 mol % of an alkali metal oxide selected from the group consisting of Li₂O, Na₂O, K₂O, and a combination thereof.

The glass substrate comprises about 27 mol % to about 43 mol % of R₂O₃, wherein R₂O₃ comprises Al₂O₃, Y₂O₃, and La₂O₃ in total. The glass substrate has a molar ratio of [(Y₂O₃+La₂O₃)/Al₂O₃] in a range of from about 0.3 to about 1.7. As described herein, La₂O₃, B₂O₃, MgO, and an alkali metal oxide such as Na₂O and K₂O are optional. When the composition comprises La₂O₃, such a composition is substantially free of B₂O₃ in some embodiments.

The glass substrate provided in the present disclosure has good properties for easy processing and excellent mechanical properties including high modulus and high fracture toughness. In some embodiments, the glass substrate has a fracture toughness (K_{IC}) in a range of from about 0.87 to about 2.0 MPa·m^{0.5}. The glass substrate also has a Young's modulus in a range of about 100 GPa to about 140 GPa, and a shear modulus in a range of about 30 GPa to about 60 GPa.

The glass substrate provided in the present disclosure has an amorphous structure providing such a fracture toughness and high modulus. However, in some other embodiments, the glass substrate may be made in crystalline structure to have further improved modulus and fracture toughness.

In other aspects, the present disclosure also provides a method of making and a method of using the glass substrate described herein, a glass article (or component) comprising such a glass substrate, and a device comprising the glass substrate or the glass article.

Examples of a glass article include, but are not limited to a panel, a substrate, an information recording disk or memory disk, a cover, a backplane, and any other components used in an electronic device. For example, in some embodiments, the glass composition or the glass substrate may be used as a substrate for a memory disk, or a cover or backplane in a display device.

### BRIEF DESCRIPTION OF THE DRAWINGS

The present disclosure is best understood from the following detailed description when read in conjunction with the accompanying drawings. It is emphasized that, according to common practice, these drawings are for illustrations of some embodiments only.

FIG. 1 graphically depicts the relationship between the softening point and the difference between the softening and strain points of exemplary glass compositions in accordance with some embodiments.

### DETAILED DESCRIPTION

This description of the exemplary embodiments is intended to be read in connection with the accompanying drawings, which are to be considered part of the entire written description. For purposes of the description hereinafter, it is to be understood that the embodiments described below may assume alternative variations and embodiments. It is also to be understood that the specific articles, compositions, and/or processes described herein are exemplary and should not be considered as limiting. All the documents cited in the present disclosure are incorporated herein by reference.

Open terms such as “include,” “including,” “contain,” “containing” and the like mean “comprising.” These open-ended transitional phrases are used to introduce an open ended list of elements, method steps or the like that does not exclude additional, unrecited elements or method steps. It is understood that wherever embodiments are described with the language “comprising,” otherwise analogous embodiments described in terms of “consisting of” and/or “consisting essentially of” are also provided.

The transitional phrase “consisting of” and variations thereof excludes any element, step, or ingredient not recited, except for impurities ordinarily associated therewith.

The transitional phrase “consists essentially of,” or variations such as “consist essentially of” or “consisting essentially of” excludes any element, step, or ingredient not recited except for those that do not materially change the basic or novel properties of the specified method, structure or composition.

In the present disclosure the singular forms “a,” “an,” and “the” include the plural reference, and reference to a particular numerical value includes at least that particular value, unless the context clearly indicates otherwise. When values are expressed as approximations, by use of the antecedent “about,” it will be understood that the particular value forms another embodiment. As used herein, “about X” (where X is a numerical value) preferably refers to ±10% of the recited value, inclusive. For example, the phrase “about 8” preferably refers to a value of 7.2 to 8.8, inclusive. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” It is intended that any component, element, attribute, or step that is positively recited herein may be explicitly excluded in the claims, whether such components, elements, attributes, or steps are listed as alternatives or whether they are recited in isolation.

The terms “substantial,” “substantially,” and variations thereof as used herein are intended to note that a described feature is equal or approximately equal to a value or description. Moreover, “substantially similar” is intended to denote that two values are equal or approximately equal. In some embodiments, “substantially similar” may denote values within about 10% of each other, such as within about 5% of each other, or within about 2% of each other.

The present disclosure provides a glass composition, a method of making the same and a method of using the same. The present disclosure also provides a glass substrate or article comprising such a glass composition, and a device comprising such a glass composition or a glass substrate having such a glass composition. Such a glass composition comprises the ingredients as described herein, including a high content of Al₂O₃, and Y₂O₃. As described herein, it was surprisingly found that such a glass composition provides high modulus and high fracture toughness, in addition to other desired properties as described herein.

In some embodiments, the substrate is optically transparent. Examples of a substrate include, but are not limited to, a flat or curved glass panel.

Unless expressly indicated otherwise, the term “glass article” or “glass” used herein is understood to encompass any object made wholly or partly of glass. Glass articles include monolithic substrates, or laminates of glass and glass, glass and non-glass materials, glass and crystalline materials, and glass and glass-ceramics (which include an amorphous phase and a crystalline phase).

The glass article such as a glass panel may be flat or curved, and is transparent or substantially transparent. As used herein, the term “transparent” is intended to denote that the article, at a thickness of approximately 1 mm, has a transmission of greater than about 85% in the visible region of the spectrum (400-700 nm). For instance, an exemplary transparent glass panel may have greater than about 85% transmittance in the visible light range, such as greater than about 90%, greater than about 95%, or greater than about 99% transmittance, including all ranges and subranges therebetween. According to various embodiments, the glass article may have a transmittance of less than about 50% in the visible region, such as less than about 45%, less than about 40%, less than about 35%, less than about 30%, less than about 25%, or less than about 20%, including all ranges and subranges therebetween. In certain embodiments, an exemplary glass panel may have a transmittance of greater than about 50% in the ultraviolet (UV) region (100-400 nm), such as greater than about 55%, greater than about 60%, greater than about 65%, greater than about 70%, greater than about 75%, greater than about 80%, greater than about 85%, greater than about 90%, greater than about 95%, or greater than about 99% transmittance, including all ranges and subranges therebetween.

Exemplary glasses can include, but are not limited to, aluminosilicate, alkali-aluminosilicate, borosilicate, alkali-borosilicate, aluminoborosilicate, alkali-aluminoborosilicate, and other suitable glasses. In some embodiments, the glass article may be strengthened mechanically by utilizing a mismatch of the coefficient of thermal expansion between portions of the article to create a compressive stress region and a central region exhibiting a tensile stress. In some embodiments, the glass article may be strengthened thermally by heating the glass to a temperature above the glass transition point and then rapidly quenching. In some other embodiments, the glass article may be chemically strengthening by ion exchange.

The term “softening point,” as used herein, refers to the temperature at which the viscosity of the glass composition is 1×10^{7.6} poise.

The term “annealing point,” as used herein, refers to the temperature at which the viscosity of the glass composition is 1×10^{13.18} poise.

The terms “strain point” and “Tₛₜᵣₐᵢₙ” as used herein, refers to the temperature at which the viscosity of the glass composition is 3×10^{14.68} poise.

The liquidus temperature of a glass (T_{liq}) is the temperature (° C.) above which no crystalline phases can coexist in equilibrium with the glass. The liquidus viscosity is the viscosity of a glass at the liquidus temperature.

The term “CTE,” as used herein, refers to the coefficient of thermal expansion of the glass composition over a temperature range from about room temperature (RT) to about 300° C.

The fracture toughness may be measured using known methods in the art, for example, using a chevron notch, short bar, notched beam and the like, according to ASTM C1421-10, “Standard Test Methods for Determination of Fracture Toughness of Advanced Ceramics at Ambient Temperature.” The fracture toughness value (K_{IC}) recited in this disclosure refers to a value as measured by chevron notched short bar (CNSB) method disclosed in Reddy, K. P. R. et al, “Fracture Toughness Measurement of Glass and Ceramic Materials Using Chevron-Notched Specimens,” J. Am. Ceram. Soc., 71 [6], C-310-C-313 (1988) except that Y*ₘ is calculated using equation 5 of Bubsey, R. T. et al., “Closed-Form Expressions for Crack-Mouth Displacement and Stress Intensity Factors for Chevron-Notched Short Bar and Short Rod Specimens Based on Experimental Compliance Measurements,” NASA Technical Memorandum 83796, pp. 1-30 (October 1992).

The Young's modulus value, the shear modulus, and Poison's ratio recited in this disclosure refers to a value (converted into GPa) as measured by a resonant ultrasonic spectroscopy technique of the general type set forth in ASTM E2001-13, titled “Standard Guide for Resonant Ultrasound Spectroscopy for Defect Detection in Both Metallic and Non-metallic Parts.”

Stress optical coefficient (SOC) values can be measured as set forth in Procedure C (Glass Disc Method) of ASTM standard C770-16, entitled “Standard Test Method for Measurement of Glass Stress-Optical Coefficient.”

In the embodiments of the glass compositions described herein, the concentrations of constituent components (e.g., SiO₂, Al₂O₃, and the like) are specified in mole percent (mol %) on an oxide basis, unless otherwise specified.

The terms “free” and “substantially free,” when used to describe the concentration and/or absence of a particular constituent component in a glass composition, means that the constituent component is not intentionally added to the glass composition. However, the glass composition may contain traces of the constituent component as a contaminant or tramp in amounts of less than 0.01 mol %.

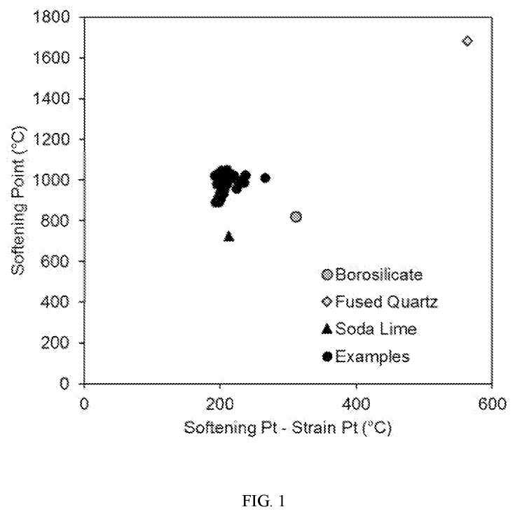

U.S. Patent Application Publication No. 2014/0141226 discloses ion-exchangeable glasses having high hardness and high elastic modulus, and describes that sodium aluminosilicate glasses containing yttria in large compositional ranges have either phase separation or devitrification. For example, according to ternary phase diagram as shown in FIG. 1 of U.S. Patent Application Publication No. 2014/0141226, when the content of Al₂O₃ was in the range of about 15 mol % to about 22 mol %, and the content of yttria was above about 7 mol %, phase separation occurred; when the content of yttria was above about 22.5 mol %, devitrification occurred. U.S. Patent Application Publication No. 2014/0141226 provides glass compositions having up to 7 mol % Y₂O₃, thus avoiding such devitrification.

U.S. Patent Application Publication No. 2018/0022635 discloses glass compositions and glass articles having high fracture toughness, which comprise one or more, particularly two or more metal oxides selected from the group consisting of La₂O₃, BaO, Ta₂O₅, Y₂O₃, and HfO₂. In such glass based articles, the content of Al₂O₃ is in the range of from about 1 mol % to about 15 mol %.

The present disclosure provides a glass composition or a glass substrate comprising the ingredients as described herein, including a high content of Al₂O₃, and Y₂O₃. It was surprisingly found that such a glass composition provides glass based articles having good quality, and having desired properties including high modulus and high fracture toughness.

In accordance with some embodiments, a glass substrate comprising:

about 45 mol % to about 70 mol % SiO₂;

about 15 mol % to about 30 mol % Al₂O₃;

about 7 mol % to about 20 mol % of Y₂O₃; and

optionally 0 mol % to about 9 mol % of La₂O₃.

In some embodiments, the glass substrate comprises about 27 mol % to about 43 mol % of R₂O₃, and wherein R₂O₃ comprises Al₂O₃, Y₂O₃, and La₂O₃ in total. Examples of a suitable range include, but are not limited to, from about 28 mol % to about 40 mol %, about 30 mol % to about 40 mol %, or about 32 mol % to about 38 mol %. In some embodiments, the glass substrate has a molar ratio of [(Y₂O₃+La₂O₃)/Al₂O₃] in a range of from about 0.3 to about 1.7, for example, from about 0.5 to about 1.7, or from about 1 to about 1.5.

In the embodiments of the glass substrates described herein, SiO₂ is the largest constituent of the composition and, as such, is the primary constituent of the glass network SiO₂ may be used to obtain the desired liquidus viscosity while, at the same time, offsetting the amount of Al₂O₃ added to the composition.

In the glass substrate, SiO₂ is present in any suitable range. Examples of a suitable range include, but are not limited to, about 50 mol % to about 70 mol %, about 52 mol % to about 70 mol %, about 52 mol % to about 66 mol %, about 54 mol % to about 66 mol %, or about 60 mol % to about 66 mol %.

The glass substrates described herein further include Al₂O₃, at a relatively high content. In some embodiments, Al₂O₃ has a content of equal to or above 15 mol %. Examples of a suitable range of Al₂O₃ include, but are not limited to, about 16 mol % to about 30 mol %, about 17 mol % to about 30 mol %, about 18 mol % to about 30 mol %, about 18 mol % to about 28 mol %, or about 18 mol % to about 25 mol %.

The glass substrates in the embodiments described herein also comprises Y₂O₃, La₂O₃, or a combination thereof, for high modulus and high fracture toughness.

In some embodiments, Y₂O₃ has a content of equal to or above 7 mol %. Examples of a suitable range of Y₂O₃ include, but are not limited to, wherein about 8 mol % to about 20 mol %, about 9 mol % to about 20 mol %, about 7 mol % to about 16 mol %, about 7 mol % to about 15 mol %, about 8 mol % to about 16 mol %, or about 10 mol % to about 16 mol %.

La₂O₃ is optional. Examples of a suitable range of La₂O₃ include, but are not limited to, about 0.1 mol % to about 9 mol %, about 1 mol % to about 9 mol %, about 2 mol % to about 9 mol %, or about 3 mol % to about 9 mol %. When the glass substrate comprises La₂O₃, such a glass substrate does not contain B₂O₃.

In some other embodiments, the glass substrate further comprises 0 mol % to about 6 mol % of B₂O₃, for example, 0.1 mol % to about 6 mol % of B₂O₃, or 0.1 mol % to about 1 mol % of B₂O₃. When B₂O₃ is added, the glass substrate is substantially free of La₂O₃. B₂O₃ and La₂O₃ are not added together in a same formulation.

The glass substrate may further comprise 0 mol % to about 6 mol % of MgO, for example, 0 to about 5 mol %, 0 to about 4 mol %, 0 to about 3 mol %, about 0.1% to about 5 mol %, about 0.1% to about 4 mol %, about 0.1 mol % to about 3 mol %.

The glass substrate may also further comprise 0 mol % to about 12 mol % of an alkali metal oxide such as Li₂O, Na₂O, K₂O, or a combination thereof. Examples of a suitable range for Li₂O, Na₂O, K₂O, or a combination thereof include, but are not limited to, 0.1 mol % to about 12 mol %, 0.1 mol % to about 10 mol %, 0.1 mol % to about 8 mol %, 0.1 mol % to about 5 mol %. In some embodiments, the content of Li₂O, Na₂O, and K₂O in total is less than 13%. In some embodiments, the glass substrate is substantially free of alkali metal oxide.

In some embodiments, a molar percentage difference of (Al₂O₃—R₂O—RO) is in a range of about 7 to about 22, for example, about 7.1 to about 21.6, about 10 to about 20, or about 15 to about 20. R₂O comprises an alkali metal oxide selected from the group consisting of Na₂O, K₂O, and any combination thereof. RO comprises an alkaline earth metal oxide selected from the group consisting of MgO, SrO, BaO, and any combination thereof. The glass substrate is substantially free of CaO.

In addition to CaO, the glass substrate is substantially free of CaO, Eu₂O₃, Nb₂O₃, Si₃N₄, WO₃, ZrO₄, and TiO₂ in some embodiments.

In accordance with some embodiments, the present disclosure provides a glass substrate consisting essentially of:

about 45 mol % to about 70 mol % SiO₂;

about 15 mol % to about 30 mol % Al₂O₃;

about 7 mol % to about 20 mol % of Y₂O₃;

0 mol % to about 9 mol % of La₂O₃;

0 mol % to about 6 mol % of MgO; and

0 mol % to about 12 mol % of an alkali metal oxide selected from the group consisting of Li₂O, Na₂O, K₂O, and a combination thereof.

The glass substrate comprises about 27 mol % to about 43 mol % of R₂O₃, wherein R₂O₃ comprises Al₂O₃, Y₂O₃, and La₂O₃ in total. The glass substrate has a molar ratio of [(Y₂O₃+La₂O₃)/Al₂O₃] in a range of from about 0.3 to about 1.7. As described herein, La₂O₃, B₂O₃, MgO, and an alkali metal oxide such as Na₂O and K₂O are optional. La₂O₃ and B₂O₃ do not coexist in the glass substrate.

In accordance with some embodiments, the present disclosure provides a glass substrate consisting essentially of:

about 45 mol % to about 70 mol % SiO₂;

about 15 mol % to about 30 mol % Al₂O₃; and

about 7 mol % to about 20 mol % of Y₂O₃.

The glass substrate provided in the present disclosure has good properties for easy processing and excellent mechanical properties including high modulus and high fracture toughness. In some embodiments, the glass substrate has a fracture toughness (K_{IC}) in a range of from about 0.87 MPa·m^{0.5} to about 2 MPa·m^{0.5}, for example, about 0.87 MPa·m^{0.5} to about 1.5 MPa·m^{0.5}, about 0.87 MPa·m^{0.5}, to about 1.2 MPa·m^{0.5}, or 0.87 to about 1.07 MPa·m^{0.5}.

In some embodiments, the glass based article can have a fracture toughness values of about 0.87 MPa*m^{0.5}, about 0.9 MPa*m^{0.5}, about 1 MPa*m^{0.5}, about 1.1 MPa*m^{0.5}, about 1.2 MPa*m^{0.5}, about 1.3 MPa*m^{0.5}, about 1.4 MPa*m^{0.5}, about 1.5 MPa*m^{0.5}, about 1.6 MPa*m^{0.5}, about 1.8 MPa*m^{0.5}, about 2 MPa*m^{0.5}, or any ranges between the specified values.

The glass substrate also provides a Young's modulus in a range of about 100 GPa to about 140 GPa, for example, about 100 GPa to about 130 GPa, about 100 GPa to about 120 GPa, about 105 GPa to about 120 GPa, about 110 GPa to about 120 GPa.

The glass substrate also provides a shear modulus in a range of about 30 GPa to about 60 GPa, about 35 GPa to about 50 GPa, about 39 GPa to about 50 GPa, or about 40 GPa to about 50 GPa.

In another aspect, the present disclosure also provides a method of making and a method of using the glass substrate described herein. A glass based article can be prepared by methods involving melting and mixing the individual oxides. However, in some embodiments, “confusion principle” can be employed to maximize mixing entropy, for example, to suppress crystallization.

The glass substrate provided in the present disclosure has an amorphous structure providing such a fracture toughness and high modulus. However, in some other embodiments, the glass substrate may be made in crystalline structure to have further improved modulus and fracture toughness.

The present disclosure also provides a glass article (or component) comprising such a glass substrate, and a device comprising the glass substrate or a glass article having the glass substrate.

Examples of a glass article include, but are not limited to a panel, a substrate, an information recording disk or memory disk, a cover, a backplane, and any other components used in an electronic device. For example, in some embodiments, the glass composition or the glass substrate may be used as a substrate for a memory disk, or a cover or backplane in a display device.

In addition to high Young's modulus and high fracture toughness, the glass substrates provided in the present disclosure have high hardness, and relatively low softening points at corresponding high strain/anneal points. The Vicker's hardness (VHN, 200 g load) may be in a range of from 700-850, for example, 750 to 850, or 767 to 818. The corresponding strain/anneal points (ASoftening-Strain Pt) can be in a range of from 190-300, for example, 190 to 270) at softening points of 890-1050° C. The relatively low softening points are shown at corresponding high strain/anneal points.

Glasses with these mechanical attributes are needed in a variety of applications ranging from memory disks, which require high Young's modulus (stiffness), to display applications. For display, high Young's modulus minimizes the effect of film stress, and high strain and anneal points minimize stress and low temperature relaxation, both of which are critical when the glass undergoes subsequent processing during thin film transistor deposition. For both of these applications, the high fracture toughness of the glasses results in improved strength for a given flaw size population. The challenges that these compositions address are longstanding and have been addressed using advantaged mechanical attributes in the past. The present disclosure provides unique glass substrates designed to take advantage of high cationic field strength of the network modifiers to achieve high modulus, high fracture toughness, and high hardness as described herein.

The density of the glass substrate is relatively high, for example, in a range of from 2.8 g/cm³ to 3.9 g/cm³. The glass substrate has relatively high refractive index (up to 1.708).

The glass substrate provided in the present disclosure has a low stress optical coefficient (SOC), which is lower than about 4 Brewster, for example, in a range of from about 1 Brewster to about 4 Brewster. As understood by those skilled in the art, SOC is related to the birefringence of the glass. The glass substrate can have a SOC of about 1 Brewster to about 3 Brewster, or about 1.5 Brewster to about 2.5 Brewster. In some embodiments, the SOC is as low as about 1.7.

In some embodiments, the glass substrate has coefficients of thermal expansion (CTEs) (22-300° C.) in a range of about 10×10⁻⁷/° C. to about 60×10⁻⁷/° C., for example, in a range of about 30×10⁻⁷/° C. to about 56×10⁻⁷/° C., or in a range of about 35×10⁻⁷/° C. to about 55×10⁻⁷/° C.

### EXAMPLES

The following examples are set forth below to illustrate the methods and results according to the disclosed subject matter. These examples are not intended to be inclusive of all embodiments of the subject matter disclosed herein, but rather to illustrate representative methods and results. These examples are not intended to exclude equivalents and variations of the present disclosure which are apparent to one skilled in the art.

Efforts have been made to ensure accuracy with respect to numbers (e.g., amounts, temperature, etc.) but some errors and deviations should be accounted for. Unless indicated otherwise, temperature is in ° C. or is at ambient temperature, and pressure is at or near atmospheric. The compositions themselves are given in mole percent on an oxide basis and have been normalized to 100%. There are numerous variations and combinations of reaction conditions, e.g., component concentrations, temperatures, pressures and other reaction ranges and conditions that can be used to optimize the product purity and yield obtained from the described process. Only reasonable and routine experimentation will be required to optimize such process conditions.

The glass properties set forth in Tables 1-7 were determined in accordance with techniques conventional in the glass art. Thus, the linear coefficient of thermal expansion (CTE) over the temperature range 25-300° C. is expressed in terms of ×10⁻⁷/° C. and the annealing point is expressed in terms of ° C. The CTE was determined following ASTM standard E228. The annealing point was determined from fiber elongation technique following ASTM standard C336, unless expressly indicated otherwise. The density in terms of grams/cm³ was measured via the Archimedes method (ASTM C693). The melting temperature in terms of ° C. (defined as the temperature at which the glass melt demonstrates a viscosity of 200 poises) was calculated employing a Fulcher equation fit to high temperature viscosity data measured via rotating cylinders viscometry (ASTM C965-81).

The liquidus temperature of the glass in terms of ° C. was measured using the standard gradient boat liquidus method of ASTM C829-81. This involves placing crushed glass particles in a platinum boat, placing the boat in a furnace having a region of gradient temperatures, heating the boat in an appropriate temperature region for 24 hours, and determining by means of microscopic examination the highest temperature at which crystals appear in the interior of the glass. More particularly, the glass sample is removed from the Pt boat in one piece, and examined using polarized light microscopy to identify the location and nature of crystals which have formed against the Pt and air interfaces, and in the interior of the sample. Because the gradient of the furnace is very well known, temperature vs. location can be well estimated, within 5-10° C. The temperature at which crystals are observed in the internal portion of the sample is taken to represent the liquidus of the glass (for the corresponding test period). Testing is sometimes carried out at longer times (e.g. 72 hours), to observe slower growing phases. The liquidus viscosity in poises was determined from the liquidus temperature and the coefficients of the Fulcher equation.

Young's modulus values in terms of GPa were determined using a resonant ultrasonic spectroscopy technique of the general type set forth in ASTM E1875-00e1.

Exemplary glasses are shown in Tables 1-7. The exemplary glasses were prepared using a commercial sand as a silica source, milled such that 90% by weight passed through a standard U.S. 100 mesh sieve. Alumina was the alumina source, and periclase was the source for MgO. Y₂O₃, La₂O₃, and B₂O₃ were also used based on the formulations. The raw materials were thoroughly mixed were double-melted and stirred for several hours at temperatures between 1600 and 1650° C. to ensure homogeneity. The resulting patties of glass were annealed at or near the annealing point, and then subjected to various experimental methods to determine physical, viscous and liquidus attributes.

These methods are not unique, and the glasses in Tables 1-7 can be prepared using standard methods well-known to those skilled in the art. Such methods include a continuous melting process, such as would be performed in a continuous melting process, wherein the melter used in the continuous melting process is heated by gas, by electric power, or combinations thereof.

Raw materials appropriate for producing exemplary glasses include commercially available sands as sources for SiO₂; alumina, aluminum hydroxide, hydrated forms of alumina, and various aluminosilicates, nitrates and halides as sources for Al₂O₃; boric acid, anhydrous boric acid and boric oxide as sources for B₂O₃; periclase, magnesia, magnesium carbonate, magnesium hydroxide, and various forms of magnesium silicates, aluminosilicates, nitrates and halides as sources for MgO. If a chemical fining agent is desired, tin can be added as SnO₂, as a mixed oxide with another major glass component (e.g., CaSnO₃), or in oxidizing conditions as SnO, tin oxalate, tin halide, or other compounds of tin known to those skilled in the art.

The glasses may also contain SnO₂ as a fining agent. Other chemical fining agents could also be employed to obtain glass of sufficient quality for TFT substrate applications. For example, exemplary glasses could employ any one or combinations of As₂O₃, Sb₂O₃, CeO₂, Fe₂O₃, and halides as deliberate additions to facilitate fining, and any of these could be used in conjunction with the SnO₂ chemical fining agent shown in the examples. Of these, As₂O₃ and Sb₂O₃ are generally recognized as hazardous materials, subject to control in waste streams such as might be generated in the course of glass manufacture or in the processing of TFT panels. It is therefore desirable to limit the concentration of As₂O₃ and Sb₂O₃ individually or in combination to no more than 0.005 mol %.

In addition to the elements deliberately incorporated into exemplary glasses, nearly all stable elements in the periodic table are present in glasses at some level, either through low levels of contamination in the raw materials, through high-temperature erosion of refractories and precious metals in the manufacturing process, or through deliberate introduction at low levels to fine tune the attributes of the final glass. For example, zirconium may be introduced as a contaminant via interaction with zirconium-rich refractories. As a further example, platinum and rhodium may be introduced via interactions with precious metals. As a further example, iron may be introduced as a tramp in raw materials, or deliberately added to enhance control of gaseous inclusions. As a further example, manganese may be introduced to control color or to enhance control of gaseous inclusions.

As a further example, alkalis may be present as a tramp component at levels up to about 0.1 mol % for the combined concentration of Li₂O, Na₂O and K₂O.

Hydrogen is inevitably present in the form of the hydroxyl anion, OH⁻, and its presence can be ascertained via standard infrared spectroscopy techniques. Dissolved hydroxyl ions significantly and nonlinearly impact the annealing point of exemplary glasses, and thus to obtain the desired annealing point it may be necessary to adjust the concentrations of major oxide components so as to compensate. Hydroxyl ion concentration can be controlled to some extent through choice of raw materials or choice of melting system. For example, boric acid is a major source of hydroxyls, and replacing boric acid with boric oxide can be a useful means to control hydroxyl concentration in the final glass. The same reasoning applies to other potential raw materials comprising hydroxyl ions, hydrates, or compounds comprising physisorbed or chemisorbed water molecules. If burners are used in the melting process, then hydroxyl ions can also be introduced through the combustion products from combustion of natural gas and related hydrocarbons, and thus it may be desirable to shift the energy used in melting from burners to electrodes to compensate.

Alternatively, one might instead employ an iterative process of adjusting major oxide components so as to compensate for the deleterious impact of dissolved hydroxyl ions.

Sulfur is often present in natural gas, and likewise is a tramp component in many carbonate, nitrate, halide, and oxide raw materials. In the form of SO₂, sulfur can be a troublesome source of gaseous inclusions. The tendency to form SO₂-rich defects can be managed to a significant degree by controlling sulfur levels in the raw materials, and by incorporating low levels of comparatively reduced multivalent cations into the glass matrix. While not wishing to be bound by theory, it appears that SO₂-rich gaseous inclusions arise primarily through reduction of sulfate (SO₄⁻) dissolved in the glass.

The elevated barium concentrations of exemplary glasses appear to increase sulfur retention in the glass in early stages of melting, but as noted above, barium is required to obtain low liquidus temperature, and hence high T₃₅ₖ-T_{liq} and high liquidus viscosity. Deliberately controlling sulfur levels in raw materials to a low level is a useful means of reducing dissolved sulfur (presumably as sulfate) in the glass. In particular, sulfur is preferably less than 200 ppm by weight in the batch materials, and more preferably less than 100 ppm by weight in the batch materials.

Reduced multivalents can also be used to control the tendency of exemplary glasses to form SO₂ blisters. While not wishing to be bound to theory, these elements behave as potential electron donors that suppress the electromotive force for sulfate reduction. Sulfate reduction can be written in terms of a half reaction such as

SO₄⁼→SO₂±O₂+2e⁻

where e⁻ denotes an electron. The “equilibrium constant” for the half reaction is

K_{eq}=[SO₂][O₂][e⁻]²/[SO₄⁼]

where the brackets denote chemical activities. Ideally one would like to force the reaction so as to create sulfate from SO₂, O₂ and 2e⁻. Adding nitrates, peroxides, or other oxygen-rich raw materials may help, but also may work against sulfate reduction in the early stages of melting, which may counteract the benefits of adding them in the first place. SO₂ has very low solubility in most glasses, and so is impractical to add to the glass melting process. Electrons may be “added” through reduced multivalents. For example, an appropriate electron-donating half reaction for ferrous iron (Fe²⁺) is expressed as

2Fe²⁺→2Fe³⁺+2e⁻

This “activity” of electrons can force the sulfate reduction reaction to the left, stabilizing SO₄⁼ in the glass. Suitable reduced multivalents include, but are not limited to, Fe²⁺, Mn²⁺, Sn²⁺, Sb³⁺, As³⁺, V³⁺, Ti³⁺, and others familiar to those skilled in the art. In each case, it may be important to minimize the concentrations of such components so as to avoid deleterious impact on color of the glass, or in the case of As and Sb, to avoid adding such components at a high enough level so as to complication of waste management in an end-user's process.

In addition to the major oxides components of exemplary glasses, and the minor or tramp constituents noted above, halides may be present at various levels, either as contaminants introduced through the choice of raw materials, or as deliberate components used to eliminate gaseous inclusions in the glass. As a fining agent, halides may be incorporated at a level of about 0.4 mol % or less, though it is generally desirable to use lower amounts if possible to avoid corrosion of off-gas handling equipment. In some embodiments, the concentrations of individual halide elements are below about 200 ppm by weight for each individual halide, or below about 800 ppm by weight for the sum of all halide elements.

Table 1 shows the compositions of Experimental Examples 1-5 (“Ex. 1-5”). Table 2 shows the compositions of Experimental Examples 6-10 (“Ex. 6-10”). Table 3 shows the compositions of Experimental Examples 11-16 (“Ex. 11-16”). Table 4 shows the compositions of Experimental Examples 17-22 (“Ex. 17-22”). Table 5 shows the compositions of Experimental Examples 23-28 (“Ex. 23-28”). Table 6 shows the compositions of Experimental Examples 29-34 (“Ex. 29-34”). Table 7 shows the compositions of Experimental Examples 35-42 (“Ex. 35-42”).

The property data of Examples 1-42 including softening point, annealing point, Young's modulus, shear modulus, Poisson's ratio, fracture toughness, and hardness are also listed in Tables 1-7. As can be seen in Tables 1-7, the exemplary glasses have good properties such as high modulus and high fracture toughness that make the glasses suitable for a variety of applications including, but not limited to memory disks and display applications, such as AMLCD substrate applications.

Referring to FIG. 1, the difference in temperature between the softening and strain points of these glasses is small relative to their softening point. The data of these glass substrates are also compared to those of generic borosilicate glass, fused quartz, and soda lime compositions. The glass compositions provided in the present disclosure also provide processing advantages over the generic glasses.

TABLE 1

| | Ex. 1 | Ex. 2 | Ex. 3 | Ex. 4 | Ex. 5 |
|---|---|---|---|---|---|
| Analyzed mol % | | | | | |
| SiO₂ | 65.2 | 65.5 | 64.9 | 63.7 | 65.0 |
| Al₂O₃ | 20.0 | 19.6 | 20.0 | 19.7 | 17.0 |
| B₂O₃ | | | | | |
| Li₂O | | | | | |
| Na₂O | | | | | |
| MgO | | | | | |
| Y₂O₃ | 13.7 | 11.8 | 10.1 | 15.5 | 14.8 |
| La₂O₃ | 1.0 | 3.0 | 4.9 | 1.0 | 3.1 |
| Sum | 99.9 | 99.9 | 99.9 | 99.9 | 99.9 |
| Al₂O₃—R₂O—RO | 20.0 | 19.6 | 20.0 | 19.7 | 17.0 |
| R₂O₃ | 34.7 | 34.5 | 35.0 | 36.2 | 34.9 |
| Density (g/cm³) | 3.265 | 3.331 | 3.384 | 3.303 | 3.468 |
| Molar Volume (cm³/mol) | 28.73 | 28.80 | 29.06 | 29.30 | 28.84 |
| Strain Point (° C.) by BBV | 841 | 836 | 830 | 845 | 839 |
| Annealing Point (° C.) by BBV | 883 | 877 | 871 | 884 | 879 |
| Softening Point (° C.) by PPV | 1051 | 1043 | 1037 | 1047 | 1041 |
| Δ(Softening Pt-Strain Pt) | 209 | 207 | 206 | 202 | 202 |
| Liquidus (° C.): Duration of test | 72 | 72 | 72 | 72 | 72 |
| (hr) | | | | | |
| Liquidus (° C.) - Air | 1355 | 1320 | 1295 | 1400 | 1430 |
| Liquidus (° C.) - Internal | 1355 | 1315 | 1290 | 1400 | 1430 |
| Liquidus (° C.) - Platinum | 1360 | 1315 | 1290 | 1400 | 1430 |
| Liquidus Phase | Unknown | Unknown | Unknown | Unknown | Unknown |
| Stress Optical Coefficient | 2.264 | 2.212 | 2.156 | 2.209 | 2.066 |
| (nm/MPa/cm) | | | | | |
| Refractive Index at 589.3 | 1.644 | 1.644 | 1.649 | 1.648 | 1.654 |
| E (Young's Modulus, Mpsi) - RUS | 15.9 | 15.7 | 15.2 | 16.1 | 16.0 |
| G (Shear Modulus, Mpsi) - RUS | 6.28 | 6.21 | 6.05 | 6.35 | 6.30 |
| Poissons Ratio - RUS | 0.268 | 0.262 | 0.267 | 0.267 | 0.271 |
| E (Young's Modulus, GPa) - RUS | 110 | 108 | 105 | 111 | 110 |
| G (Shear Modulus, GPa) - RUS | 43.3 | 42.8 | 41.7 | 43.8 | 43.4 |

TABLE 2

| | Ex. 6 | Ex. 7 | Ex. 8 | Ex. 9 | Ex. 10 |
|---|---|---|---|---|---|
| Analyzed mol % | | | | | |
| SiO₂ | 63.6 | 63.2 | 63.5 | 63.6 | 63.6 |
| Al₂O₃ | 19.7 | 18.1 | 15.8 | 13.6 | 11.9 |
| B₂O₃ | | | | | |
| Li₂O | 1.0 | 2.0 | 3.0 | 4.0 | 4.8 |
| Na₂O | | | | | |
| MgO | | | | | |
| Y₂O₃ | 14.6 | 14.6 | 14.6 | 14.8 | 14.6 |
| La₂O₃ | 1.0 | 2.0 | 3.1 | 3.9 | 5.0 |
| Sum | 99.9 | 99.9 | 99.9 | 99.9 | 99.9 |
| Al₂O₃—R₂O—RO | 18.7 | 16.1 | 12.8 | 9.7 | 7.1 |
| R₂O₃ | 35.3 | 34.7 | 33.5 | 32.3 | 31.4 |
| Density (g/cm³) | 3.304 | 3.390 | 3.460 | 3.535 | 3.621 |
| Molar Volume (cm³/mol) | 28.71 | 28.49 | 28.38 | 28.14 | 27.91 |
| Strain Point (° C.) by BBV | 817 | 796 | 778 | 759 | 746 |
| Annealing Point (° C.) by BBV | 858 | 837 | 820 | 800 | 787 |
| Softening Point (° C.) by PPV | 1032 | 1010 | 982 | 964 | 949 |
| Δ(Softening Pt-Strain Pt) | 215 | 214 | 203 | 205 | 203 |
| Liquidus (° C.): Duration of test | 72 | 72 | 72 | 72 | 72 |
| (hr) | | | | | |
| Liquidus (° C.) - Air | 1395 | 1430 | >1375 | >1345 | >1330 |
| Liquidus (° C.) - Internal | 1395 | 1430 | >1375 | >1345 | >1330 |
| Liquidus (° C.) - Platinum | 1405 | 1430 | >1375 | >1345 | >1330 |
| Liquidus Phase | | Unknown | Unknown | Unknown | Unknown |
| Stress Optical Coefficient | 2.170 | 2.114 | 2.060 | 1.987 | 1.896 |
| (nm/MPa/cm) | | | | | |
| Refractive Index at 589.3 | 1.644 | 1.653 | 1.660 | 1.669 | 1.678 |
| E (Young's Modulus, Mpsi) - RUS | 16.2 | 16.3 | 16.1 | 16.2 | 16.3 |
| G (Shear Modulus, Mpsi) - RUS | 6.41 | 6.43 | 6.38 | 6.40 | 6.38 |
| Poissons Ratio - RUS | 0.264 | 0.266 | 0.262 | 0.267 | 0.275 |
| E (Young's Modulus, GPa) - RUS | 112 | 112 | 111 | 112 | 112 |
| G (Shear Modulus, GPa) - RUS | 44.2 | 44.3 | 44.0 | 44.1 | 44.0 |
| Fracture toughness (MPa * sqrt(m)) | | | | 0.95 | 0.95 |
| standard deviation | | | | 0.02 | 0.02 |

TABLE 3

| | Ex. 11 | Ex. 12 | Ex. 13 | Ex. 14 | Ex. 15 | Ex. 16 |
|---|---|---|---|---|---|---|
| Analyzed mol % | | | | | | |
| SiO₂ | 63.75 | 61.41 | 59.68 | 57.84 | 55.86 | 53.94 |
| Al₂O₃ | 19.69 | 19.7 | 19.69 | 19.8 | 19.69 | 19.7 |
| B₂O₃ | | | | | | |
| Li₂O | 1.94 | 4.02 | 5.8 | 7.89 | 9.88 | 11.85 |
| Na₂O | | | | | | |
| MgO | | | | | | |
| Y₂O₃ | 14.43 | 14.68 | 14.64 | 14.27 | 14.39 | 14.33 |
| La₂O₃ | | | | | | |
| Sum | 99.81 | 99.81 | 99.81 | 99.8 | 99.82 | 99.82 |
| Al₂O₃—R₂O—RO | 17.8 | 15.7 | 13.9 | 11.9 | 9.8 | 7.9 |
| R₂O₃ | 34.1 | 34.4 | 34.3 | 34.1 | 34.1 | 34.0 |
| Density (g/cm³) | 3.258 | 3.265 | 3.231 | 3.232 | 3.231 | 3.233 |
| Molar Volume (cm³/mol) | 28.14 | 28.01 | 28.12 | 27.74 | 27.61 | 27.38 |
| Expansion (10⁻⁷/° C.) | 48 | 50 | 45 | | | |
| Strain Point (° C.) by BBV | 801 | 773 | 751 | 730 | 710 | 695 |
| Annealing Point (° C.) by | 842 | 815 | 792 | 769 | 749 | 733 |
| BBV | | | | | | |
| Softening Point (° C.) by PPV | 1011 | 983 | 953 | 935 | 911 | 892 |
| Δ(Softening Pt-Strain Pt) | 210 | 210 | 202 | 205 | 201 | 197 |
| Liquidus (° C.): Duration of | 72 | 72 | 72 | 72 | 72 | 72 |
| test (hr) | | | | | | |
| Liquidus (° C.) - Air | 1335 | 1405 | 1405 | 1410 | 1415 | 1415 |
| Liquidus (° C.) - Internal | 1335 | 1410 | 1405 | 1410 | 1415 | 1420 |
| Liquidus (° C.) - Platinum | 1335 | 1420 | 1405 | 1410 | 1415 | 1425 |
| Liquidus Phase | Unknown | Unknown | Unknown | Unknown | | lithium |
| | | | | | | yttrium |
| | | | | | | silicate |
| | | | | | | aluminum |
| | | | | | | yttrium |
| | | | | | | oxide |
| Stress Optical Coefficient | | 2.225 | 2.202 | 2.168 | 2.138 | 2.113 |
| (nm/MPa/cm) | | | | | | |
| Refractive Index at 589.3 | 1.633 | 1.637 | 1.639 | 1.641 | 1.643 | 1.644 |
| E (Young's Modulus, Mpsi) - | 16.1 | 16.3 | 16.3 | 16.4 | 16.3 | 16.4 |
| RUS | | | | | | |
| G (Shear Modulus, Mpsi) - | 6.39 | 6.45 | 6.42 | 6.47 | 6.45 | 6.46 |
| RUS | | | | | | |
| Poissons Ratio - RUS | 0.262 | 0.262 | 0.271 | 0.270 | 0.263 | 0.265 |
| E (Young's Modulus, GPa) - | 111 | 112 | 113 | 113 | 112 | 113 |
| RUS | | | | | | |
| G (Shear Modulus, GPa) - | 44.1 | 44.5 | 44.3 | 44.6 | 44.5 | 44.5 |
| RUS | | | | | | |
| Fracture toughness (MPa * | 1.04 | 0.94 | 0.96 | 0.97 | 0.94 | 0.91 |
| sqrt(m)) | | | | | | |
| standard deviation | 0.08 | 0.02 | 0.02 | 0.02 | 0.03 | 0.02 |
| Hardness - Vicker's 200 g | 807 | | | | | 818 |
| load | | | | | | |
| Hardness - stdev | 15 | | | | | 22 |

TABLE 4

| | Ex. 17 | Ex. 18 | Ex. 19 | Ex. 20 | Ex. 21 | Ex. 22 |
|---|---|---|---|---|---|---|
| Analyzed mol % | | | | | | |
| SiO₂ | 61.49 | 57.49 | 54.39 | 59.4 | 58.6 | 57.7 |
| Al₂O₃ | 21.8 | 23.65 | 25.18 | 19.0 | 18.7 | 18.8 |
| B₂O₃ | | | | | | |
| Li₂O | 1.92 | 3.92 | 5.79 | 5.9 | 6.9 | 7.9 |
| Na₂O | | | | | | |
| MgO | | | | | | |
| Y₂O₃ | 14.57 | 14.73 | 14.42 | 15.4 | 15.6 | 15.4 |
| La₂O₃ | | | | | | |
| Sum | 99.78 | 99.79 | 99.78 | 99.8 | 99.8 | 99.8 |
| Al₂O₃—R₂O—RO | 19.9 | 19.7 | 19.4 | 13.1 | 11.8 | 10.9 |
| R₂O₃ | 36.4 | 38.4 | 39.6 | 34.5 | 34.3 | 34.2 |
| Density (g/cm³) | 3.239 | 3.237 | 3.246 | 3.284 | 3.289 | 3.28 |
| Molar Volume (cm³/mol) | 28.64 | 28.80 | 28.59 | 27.97 | 27.87 | 27.76 |
| Expansion (10⁻⁷/° C.) | 48 | 51 | 45 | | | |
| Strain Point (° C.) by BBV | 802 | 773 | 753 | 749 | 739 | 731 |
| Annealing Point (° C.) by | 843 | 814 | 793 | 789 | 779 | 770 |
| BBV | | | | | | |
| Softening Point (° C.) by PPV | 1010 | 978 | 955 | 956 | 938 | 932 |
| Δ(Softening Pt-Strain Pt) | 209 | 205 | 202 | 206 | 200 | 202 |
| Liquidus (° C.): Duration of | 72 | 72 | 72 | 72 | 72 | 72 |
| test (hr) | | | | | | |
| Liquidus (° C.) - Air | 1410 | 1400 | 1380 | 1440 | 1430 | 1430 |
| Liquidus (° C.) - Internal | 1410 | 1400 | 1380 | 1440 | 1430 | 1435 |
| Liquidus (° C.) - Platinum | 1410 | 1400 | 1375 | 1440 | 1430 | 1440 |
| Liquidus Phase | Unknown | Unknown | Unknown | Unknown | Unknown | Unknown |
| Stress Optical Coefficient | 2.231 | 2.174 | 2.147 | 2.160 | 2.145 | 2.131 |
| (nm/MPa/cm) | | | | | | |
| Refractive Index at 589.3 | 1.640 | 1.642 | 1.645 | 1.646 | 1.647 | 1.649 |
| E (Young's Modulus, Mpsi) - | 16.6 | 16.8 | 16.7 | 16.4 | 16.4 | 16.5 |
| RUS | | | | | | |
| G (Shear Modulus, Mpsi) - | 6.55 | 6.60 | 6.62 | 6.49 | 6.47 | 6.48 |
| RUS | | | | | | |
| Poissons Ratio - RUS | 0.264 | 0.269 | 0.261 | 0.265 | 0.267 | 0.274 |
| E (Young's Modulus, GPa) - | 114 | 115 | 115 | 113 | 113 | 114 |
| RUS | | | | | | |
| G (Shear Modulus, GPa) - | 45.2 | 45.5 | 45.6 | 44.7 | 44.6 | 44.7 |
| RUS | | | | | | |
| Fracture toughness (MPa * | 0.97 | 0.95 | 0.96 | 0.94 | 0.95 | 0.95 |
| sqrt(m)) | | | | | | |
| standard deviation | 0.02 | 0.03 | 0.03 | 0.02 | 0.02 | 0.03 |
| Hardness - Vicker's 200 g | 803 | | | | | |
| load | | | | | | |
| Hardness - stdev | 21 | | | | | |

TABLE 5

| | Ex. 23 | Ex. 24 | Ex. 25 | Ex. 26 | Ex. 27 | Ex. 28 |
|---|---|---|---|---|---|---|
| Analyzed mol % | | | | | | |
| SiO₂ | 61.0 | 64.7 | 65.0 | 62.08 | 60.58 | 59.68 |
| Al₂O₃ | 19.9 | 20.1 | 20.0 | 20.38 | 20.2 | 19.7 |
| B₂O₃ | | | | 2.01 | 4 | 5.94 |
| Li₂O | | 2.0 | 4.0 | 2.01 | 2 | 1.98 |
| Na₂O | | | | | | |
| MgO | 4.0 | 2.0 | 4.0 | 2.06 | 2.01 | 1.91 |
| Y₂O₃ | 14.9 | 11.1 | 6.9 | 11.3 | 11.06 | 10.64 |
| La₂O₃ | | | | | | |
| Sum | 99.8 | 99.8 | 99.9 | 99.84 | 99.85 | 99.85 |
| Al₂O₃—R₂O—RO | 16.0 | 16.0 | 12.0 | 16.3 | 16.2 | 15.8 |
| R₂O₃ | 34.8 | 31.1 | 26.9 | 31.7 | 31.3 | 30.3 |
| Density (g/cm³) | 3.28 | 3.033 | 2.837 | 3.042 | 3.039 | 3.008 |
| Molar Volume (cm³/mol) | 28.16 | 28.30 | 27.44 | 28.45 | 28.39 | 28.45 |
| Expansion (10⁻⁷/° C.) | | 45 | 38 | 41 | 41 | 42 |
| Strain Point (° C.) by | | 788 | 745 | 770 | 828 | 786 |
| fiber elongation | | | | | | |
| Annealing Point (° C.) | | 831 | 790 | 813 | 869 | 828 |
| by fiber elongation | | | | | | |
| Softening Point (° C.) | | 1006 | 976 | 1021 | 1034 | 996 |
| by fiber elongation | | | | | | |
| Strain Point (° C.) by | 822 | 787 | 745 | 814 | 828 | 786 |
| BBV | | | | | | |
| Annealing Point (° C.) | 864 | 831 | 789 | 856 | 869 | 828 |
| by BBV | | | | | | |
| Softening Point (° C.) | 1036 | 981 | 1010 | 1021 | 1034 | 996 |
| by PPV | | | | | | |
| Δ(Softening Pt-Strain Pt) | 214 | 195 | 266 | 207 | 206 | 210 |
| Liquidus (° C.): Duration of | 72 | 72 | 72 | 72 | 72 | 72 |
| test (hr) | | | | | | |
| Liquidus (° C.) - Air | 1375 | 1340 | 1400 | 1365 | 1325 | 1360 |
| Liquidus (° C.) - Internal | 1375 | 1345 | 1390 | 1350 | 1320 | 1330 |
| Liquidus (° C.) - Platinum | 1375 | 1335 | 1390 | 1355 | 1325 | 1330 |
| Liquidus Phase | Unknown | Protoenstatite | Protoenstatite | Mullite | Mullite | Mullite |
| Stress Optical Coefficient | | | | | | |
| (nm/MPa/cm) | | | | | | |
| Refractive Index at 589.3 | 2.173 | 2.399 | 2.559 | 2.251 | 2.282 | 2.277 |
| E (Young's Modulus, Mpsi) - | 1.645 | 1.608 | 1.580 | 1.641 | 1.633 | 1.632 |
| RUS | | | | | | |
| G (Shear Modulus, Mpsi) - | 16.6 | 17.4 | 15.0 | 16.1 | 15.8 | 15.8 |
| RUS | | | | | | |
| Poissons Ratio - RUS | 6.52 | 6.78 | 5.99 | 6.38 | 6.25 | 6.30 |
| E (Young's Modulus, GPa) - | 0.271 | 0.281 | 0.250 | 0.261 | 0.264 | 0.255 |
| RUS | | | | | | |
| G (Shear Modulus, GPa) - | 114 | 120 | 103 | 111 | 109 | 109 |
| RUS | | | | | | |
| Fracture toughness (MPa * | 45.0 | 46.7 | 41.3 | 44.0 | 43.1 | 43.4 |
| sqrt(m)) | | | | | | |
| standard deviation | 1.02 | 0.97 | 0.95 | 0.95 | 0.90 | 0.96 |
| Hardness - Vicker's 200 g | 0.03 | 0.03 | 0.03 | 0.02 | 0.03 | 0.03 |
| load | | | | | | |
| Hardness - stdev | | 767 | | | | |
| | | 34 | | | | |

TABLE 6

| | Ex. 29 | Ex. 30 | Ex. 31 | Ex. 32 | Ex. 33 | Ex. 34 |
|---|---|---|---|---|---|---|
| Analyzed mol % | | | | | | |
| SiO₂ | 64.68 | 61.76 | 59.24 | 59.7 | 57.7 | 54.0 |
| Al₂O₃ | 19.31 | 19.9 | 19.98 | 19.9 | 20.0 | 20.0 |
| B₂O₃ | 1.97 | 3.96 | 5.98 | | | |
| Li₂O | | | | | | |
| Na₂O | 1.7 | 1.71 | 1.77 | 5.6 | 7.5 | 11.2 |
| MgO | 1.85 | 1.89 | 1.97 | | | |
| Y₂O₃ | 10.36 | 10.65 | 10.94 | 14.7 | 14.7 | 14.7 |
| La₂O₃ | | | | | | |
| Sum | 99.87 | 99.87 | 99.88 | 99.9 | 99.9 | 99.8 |
| Al₂O₃—R₂O—RO | 15.8 | 16.3 | 16.2 | 14.4 | 12.5 | 8.8 |
| R₂O₃ | 29.7 | 30.6 | 30.9 | 34.6 | 34.6 | 34.6 |
| Density (g/cm³) | 3.057 | 3.008 | 3.012 | 3.216 | 3.219 | 3.195 |
| Molar Volume (cm³/mol) | 27.88 | 28.63 | 28.82 | 28.90 | 28.87 | 29.11 |
| Expansion (10⁻⁷/° C.) | 43 | 42 | 42 | | | |
| Strain Point (° C.) by fiber | 816 | 768 | 801 | | | |
| elongation | | | | | | |
| Annealing Point (° C.) by fiber | 858 | 808 | 842 | | | |
| elongation | | | | | | |
| Softening Point (° C.) by fiber | 1023 | 971 | 1003 | | | |
| elongation | | | | | | |
| Strain Point (° C.) by BBV | 816 | 768 | 801 | 802 | 793 | 784 |
| Annealing Point (° C.) by BBV | 858 | 808 | 842 | 843 | 836 | 826 |
| Softening Point (° C.) by PPV | 1023 | 971 | 1003 | 1022 | 1013 | 990 |
| Δ(Softening Pt-Strain Pt) | 207 | 203 | 202 | 220 | 220 | 206 |
| Liquidus (° C.): Duration of test | 72 | 72 | 72 | 72 | 72 | 72 |
| (hr) | | | | | | |
| Liquidus (° C.) - Air | 1350 | 1350 | 1330 | 1465 | 1470 | 1560 |
| Liquidus (° C.) - Internal | 1345 | 1345 | 1330 | 1470 | 1470 | 1570 |
| Liquidus (° C.) - Platinum | 1350 | 1350 | 1330 | 1470 | 1470 | 1570 |
| Liquidus Phase | Mullite | Mullite | Mullite | Unknown | Unknown | Unknown |
| Stress Optical Coefficient | 2.306 | 2.216 | 2.240 | 2.316 | 2.294 | 2.221 |
| (nm/MPa/cm) | | | | | | |
| Refractive Index at 589.3 | 1.628 | 1.642 | 1.631 | 1.622 | 1.619 | 1.624 |
| E (Young's Modulus, Mpsi) - | 15.4 | 16.4 | 15.7 | 15.2 | 15.0 | 14.5 |
| RUS | | | | | | |
| G (Shear Modulus, Mpsi) - | 6.10 | 6.49 | 6.21 | 6.01 | 5.92 | 5.76 |
| RUS | | | | | | |
| Poissons Ratio - RUS | 0.260 | 0.263 | 0.263 | 0.264 | 0.264 | 0.258 |
| E (Young's Modulus, GPa) - | 106 | 113 | 108 | 105 | 103 | 100 |
| RUS | | | | | | |
| G (Shear Modulus, GPa) - RUS | 42.1 | 44.7 | 42.8 | 41.4 | 40.8 | 39.7 |
| Fracture toughness (MPa * | 0.95 | 0.94 | 0.93 | 0.89 | 0.87 | 0.87 |
| sqrt(m)) | | | | | | |
| standard deviation | 0.03 | 0.06 | 0.01 | 0.03 | 0.03 | 0.03 |
| Hardness - Vicker's 200 g load | | | | | | |
| Hardness - stdev | | | | | | |

TABLE 7

| | Ex. 35 | Ex. 36 | Ex. 37 | Ex. 38 | Ex. 39 | Ex. 40 | Ex. 41 | Ex. 42 |
|---|---|---|---|---|---|---|---|---|
| Analyzed mol % | | | | | | | | |
| SiO₂ | 63.4 | 64.1 | 64.1 | 62.3 | 53.2 | 63.95 | 61.42 | 54.27 |
| Al₂O₃ | 19.9 | 15.6 | 19.6 | 19.6 | 26.8 | 19.59 | 20.11 | 25.51 |
| B₂O₃ | | | | | | | | |
| Li₂O | | | | | | 0.95 | 1.89 | 2.86 |
| Na₂O | 0.8 | 2.6 | 1.7 | 3.6 | 5.2 | 0.82 | 1.8 | 2.72 |
| MgO | | | | | | | | |
| Y₂O₃ | 14.7 | 14.6 | 14.5 | 14.4 | 14.6 | 14.5 | 14.6 | 14.46 |
| La₂O₃ | 1.1 | 2.9 | | | | | | |
| Sum | 99.9 | 99.9 | 99.8 | 99.8 | 99.8 | 99.81 | 99.82 | 99.82 |
| Al₂O₃—R₂O—RO | 19.1 | 13.0 | 17.9 | 16.0 | 21.6 | 17.8 | 16.4 | 19.9 |
| R₂O₃ | 35.7 | 33.1 | 34.0 | 34.0 | 41.4 | 34.1 | 34.7 | 40.0 |
| Density (g/cm³) | 3.301 | 3.435 | 3.211 | 3.218 | 3.241 | 3.224 | 3.235 | 3.243 |
| Molar Volume | 28.95 | 28.72 | 28.76 | 28.66 | 29.51 | 28.56 | 28.50 | 28.96 |
| (cm³/mol) | | | | | | | | |
| Expansion (10⁻⁷/° C.) | 46 | 53 | 46 | 51 | 53 | 46 | 50 | 52 |
| Strain Point (° C.) | 833 | 817 | 751 | 787 | 754 | 767 | 736 | 769 |
| by BBV | | | | | | | | |
| Annealing Point | 874 | 859 | 796 | 833 | 800 | 811 | 780 | 815 |
| (° C.) by BBV | | | | | | | | |
| Softening Point | 1035 | 1014 | 977 | 1024 | 989 | 993 | 960 | 998 |
| (° C.) by PPV | | | | | | | | |
| Δ(Softening Pt- | 202 | 197 | 226 | 236 | 235 | 227 | 224 | 229 |
| Strain Pt) | | | | | | | | |
| Liquidus (° C.): | 72 | 72 | 72 | 72 | 72 | 72 | 72 | 72 |
| Duration of test (hr) | | | | | | | | |
| Liquidus (° C.) - Air | >1330 | >1330 | 1440 | >1465 | >1445 | 1420 | 1445 | 1425 |
| Liquidus (° C.) - | >1330 | >1330 | 1445 | 1465 | 1445 | 1430 | 1445 | 1430 |
| Internal | | | | | | | | |
| Liquidus (° C.) - | >1330 | >1370 | >1445 | >1465 | >1445 | 1440 | 1445 | >1450 |
| Platinum | | | | | | | | |
| Liquidus Phase | Unknown | Unknown | Unknown | Unknown | Unknown | Unknown | Unknown | Unknown |
| Stress Optical | 2.197 | 2.114 | 2.453 | 2.495 | 2.539 | 2.442 | 2.492 | 2.484 |
| Coefficient | | | | | | | | |
| (nm/MPa/cm) | | | | | | | | |
| Refractive Index at | 1.645 | 1.655 | 1.606 | 1.605 | 1.601 | 1.607 | 1.606 | 1.604 |
| 589.3 | | | | | | | | |
| E (Young's | 16.1 | 15.5 | 15.4 | 15.1 | 14.8 | 15.5 | 15.3 | 15.0 |
| Modulus, Mpsi) - | | | | | | | | |
| RUS | | | | | | | | |
| G (Shear Modulus, | 6.33 | 6.13 | 6.10 | 6.00 | 5.88 | 6.15 | 6.07 | 5.96 |
| Mpsi) - RUS | | | | | | | | |
| Poissons Ratio - | 0.270 | 0.266 | 0.259 | 0.258 | 0.259 | 0.257 | 0.258 | 0.258 |
| RUS | | | | | | | | |
| E (Young's | 111 | 107 | 106 | 104 | 102 | 107 | 105 | 103 |
| Modulus, GPa) - | | | | | | | | |
| RUS | | | | | | | | |
| G (Shear Modulus, | 43.6 | 42.3 | 42.1 | 41.4 | 40.5 | 42.4 | 41.9 | 41.1 |
| GPa) - RUS | | | | | | | | |
| Fracture toughness | 0.97 | 0.95 | 0.92 | 0.95 | 0.96 | 0.94 | 1.07 | 1.03 |
| (MPa * sqrt(m)) | | | | | | | | |
| standard deviation | 0.02 | 0.05 | | 0.03 | 0.01 | 0.02 | 0.06 | 0.00 |

Although the subject matter has been described in terms of exemplary embodiments, it is not limited thereto. Rather, the appended claims should be construed broadly, to include other variants and embodiments, which may be made by those skilled in the art.

What is claimed is:

1. A glass substrate comprising:
about 45 mol % to about 70 mol % SiO₂;
about 15 mol % to about 30 mol % Al₂O₃;
about 7 mol % to about 20 mol % of Y₂O₃; and
optionally 0 mol % to about 9 mol % of La₂O₃.

2. The glass substrate of claim 1, wherein the glass substrate comprises about 27 mol % to about 43 mol % of R₂O₃, and wherein R₂O₃ comprises Al₂O₃, Y₂O₃, and La₂O₃.

3. The glass substrate of claim 2, wherein R₂O₃ is in a range of from about 28 mol % to about 40 mol %, about 30 mol % to about 40 mol %, or about 32 mol % to about 38 mol %.

4. The glass substrate of claim 1, wherein the glass substrate has a molar ratio of [(Y₂O₃+La₂O₃)/Al₂O₃] in a range of from about 0.3 to about 1.7.

5. The glass substrate of claim 1, wherein SiO₂ is in a range of about 50 mol % to about 70 mol %, about 52 mol % to about 70 mol %, about 52 mol % to about 66 mol %, about 54 mol % to about 66 mol %, or about 60 mol % to about 66 mol %.

6. The glass substrate of claim 1, wherein Al₂O₃ is in a range of about 16 mol % to about 30 mol %, about 17 mol % to about 30 mol %, about 18 mol % to about 30 mol %, about 18 mol % to about 28 mol %, or about 18 mol % to about 25 mol %.

7. The glass substrate of claim 1, wherein Y₂O₃ is in a range of about 8 mol % to about 20 mol %, about 9 mol % to about 20 mol %, about 7 mol % to about 16 mol %, about 7 mol % to about 15 mol %, about 8 mol % to about 16 mol %, or about 10 mol % to about 16 mol %.

8. The glass substrate of claim 1, wherein La₂O₃ is in a range of about 0.1 mol % to about 9 mol %, about 1 mol % to about 9 mol %, about 2 mol % to about 9 mol %, or about 3 mol % to about 9 mol %.

9. The glass substrate of claim 1, further comprising 0 mol % to about 6 mol % of B₂O₃, wherein the glass substrate is substantially free of La₂O₃.

10. The glass substrate of claim 1, further comprising 0 mol % to about 6 mol % of MgO.

11. The glass substrate of claim 1, further comprising 0 mol % to about 12 mol % of Li₂O, Na₂O, K₂O, or a combination thereof.

12. The glass substrate of claim 1, wherein a molar percentage difference of (Al₂O₃—R₂O—RO) in a range of about 7 to about 22, wherein R₂O comprises an alkali metal oxide selected from the group consisting of Li₂O, Na₂O, K₂O, and any combination thereof, and RO comprises an alkaline earth metal oxide selected from the group consisting of MgO, SrO, BaO, and any combination thereof.

13. The glass substrate of claim 1, wherein the glass substrate is substantially free of CaO, Eu₂O₃, Nb₂O₃, Si₃N₄, WO₃, ZrO₄, and TiO₂.

14. The glass substrate of claim 1, wherein the glass substrate has a fracture toughness (K_{IC}) in a range of from about 0.87 to about 2.0 MPa·m^{0.5}.

15. The glass substrate of claim 1, wherein the glass substrate has a Young's modulus in a range of about 100 GPa to about 140 GPa, and a shear modulus in a range of about 30 GPa to about 60 GPa.

16. A glass substrate consisting essentially of:
about 45 mol % to about 70 mol % SiO₂;
about 15 mol % to about 30 mol % Al₂O₃;
about 7 mol % to about 20 mol % of Y₂O₃;
0 mol % to about 9 mol % of La₂O₃;
0 mol % to about 6 mol % of MgO; and
0 mol % to about 12 mol % of an alkali metal oxide selected from the group consisting of Li₂O Na₂O, K₂O, and a combination thereof.

17. The glass substrate of claim 16, wherein the glass substrate comprises about 27 mol % to about 43 mol % of R₂O₃, wherein R₂O₃ comprises Al₂O₃, Y₂O₃, and La₂O₃; and wherein the glass substrate has a molar ratio of [(Y₂O₃+La₂O₃)/Al₂O₃] in a range of from about 0.3 to about 1.7.

18. A glass article comprising the glass substrate of claim 1 or claim 16.

19. A device comprising the glass substrate of claim 1 or claim 16.

20. The device of claim 19, wherein the device is an electronic device for display application.

21. The device of claim 19, wherein the device is an information recording disk.
